(19) United States
(12) Patent Application Publication
(10) Pub. No.: US 2014/0125527 A1
(43) Pub. Date: May 8, 2014

(54) MULTI-BAND ANTENNA

(71) Applicant: HON HAI PRECISION INDUSTRY CO., LTD., New Taipei (TW)

(72) Inventor: LUNG-SHENG TAI, New Taipei (TW)

(73) Assignee: HON HAI PRECISION INDUSTRY CO., LTD., New Taipei (TW)

(21) Appl. No.: 14/073,884

(22) Filed: Nov. 7, 2013

(30) Foreign Application Priority Data
Nov. 7, 2012 (TW) 101141447

(51) Int. Cl. H01Q 9/04

(52) U.S. Cl. CPC H01Q 9/04
USPC 343/700 MS

(57) ABSTRACT

An multi-band antenna includes a base section including a first end and a second end opposite to each other, a first radiating arm and a second radiating arm extending opposite to each other from the first end and locating on two opposite sides of the base section in a longitudinal direction, and a loop conductive portion extending from the base section. The loop conductive portion includes a grounding portion locating adjacent to the second end of the base section and a connecting portion extending in the longitudinal direction. The connecting portion is located on the same side of the base section with the first radiating arm.

### BACKGROUND OF THE INVENTION

1. Field of the Invention

The present disclosure relates to a multi-band antenna, and more particularly to a multi-band antenna covering a broader frequency band.

2. Description of Related Art

Long Term Evolution (LTE) is an advanced technology in wireless communication for portable electronic devices and other data terminals. The LTE provides downlink rates of 100 Mbit/s, uplink rates of 50 Mbit/s on frequency band of 20 MHz which will be of great benefit to the wireless communication services. The frequency band of 3G is 824˜960 MHz and 1710˜2170 MHz while the LTE is 704˜960 MHz and 1710˜2700 MHz which covers the frequency band of 3G. The LTE is better than the 3G wireless communication. Thus, it is necessary to provide an antenna that can satisfy the standard of the LTE.

In view of the above, an improved antenna is desired to overcome the problems mentioned above.

### SUMMARY OF THE INVENTION

Accordingly, an object of the present disclosure is to provide an antenna which is capable of covering a broader band.

According to one aspect of the present disclosure, a multi-band antenna capable of meeting the requirements of both 3G and LTE is provided. The multi-band antenna comprising: a base section comprising a first end and a second end opposite to each other; a first radiating arm and a second radiating arm extending opposite to each other from the first end and locating on two opposite sides of the base section in a longitudinal direction; and a loop conductive portion extending from the base section, the loop conductive portion comprising a grounding portion locating adjacent to the second end of the base section and a connecting portion extending in the longitudinal direction, the connecting portion locating on the same side of the base section with the first radiating arm and defining a main matching slot thereon.

Other objects, advantages and novel features of the disclosure will become more apparent from the following detailed description when taken in conjunction with the accompanying drawings, in which:

### BRIEF DESCRIPTION OF THE DRAWINGS

FIG. 1 is a perspective, exploded view of an antenna in accordance with a preferred embodiment of the present disclosure;

FIG. 2 is a perspective, assembled view of the antenna shown in FIG. 1;

FIG. 3 is another perspective, exploded view of the antenna shown in FIG. 1;

FIG. 4 is a top view of the antenna.

### DETAILED DESCRIPTION OF THE INVENTION

Reference will now be made to the drawings to describe a preferred embodiment of the present disclosure in detail.

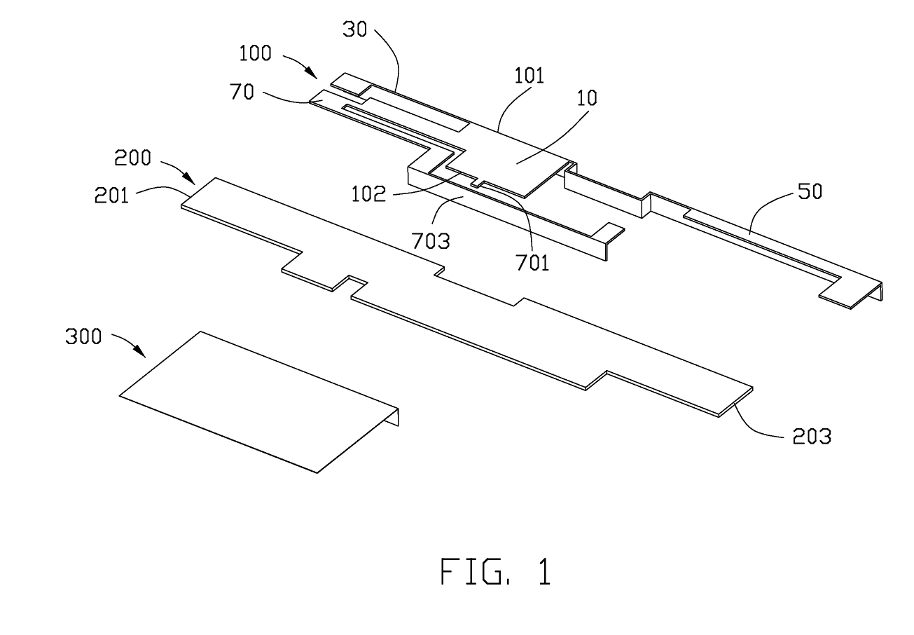

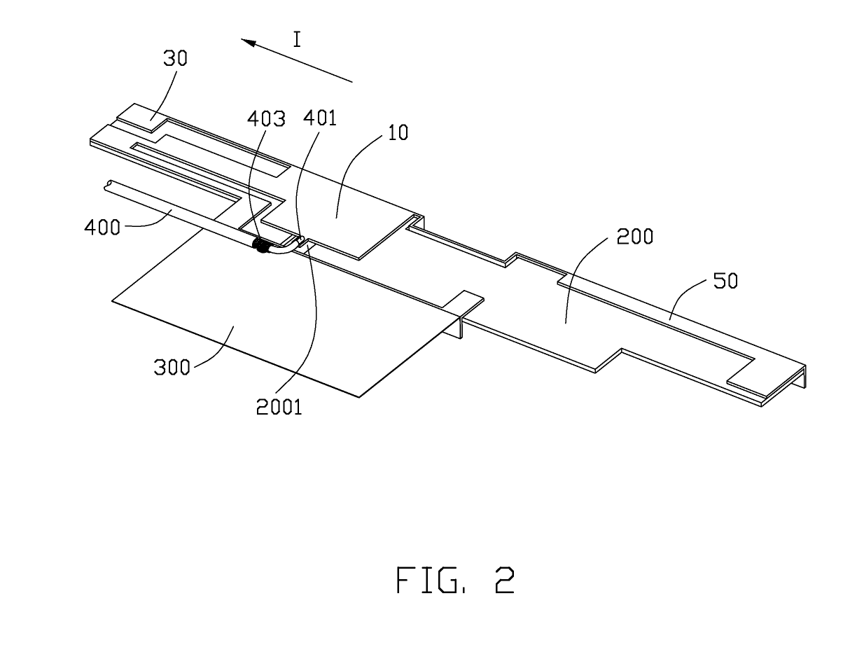

Referring to FIG. 1 and FIG. 2, an antenna 100 in accordance with the preferred embodiment of the present disclosure is assembled on an insulating board 200. The antenna 100 comprises a base section 10 defining a first end 101 and a second end 102 opposite to each other in a transverse direction, a first radiating arm 30 and a second radiating arm 50 extending opposite to each other from the first end 101, and a loop conductive portion 70 adjacent to the second end 102. The insulating board 200 comprises a first side 201 and a second side 203 opposite to each other in a longitudinal direction perpendicular to the transverse direction.

The base section 10 comprises a third end 103 and a fourth end 104 perpendicular to the first and second end 101, 102. The base section 10 is a rectangular plate formed by the first end 101, the third end 103, the second end 102 and the fourth end 104 connecting each other successively. The first radiating arm 30 locates on the third end 103 of the base section 10 and extends towards the first side 201 of the insulating board 200 while the second radiating arm 50 locates on the fourth end 104 of the base section 10 and extends towards the second side 203 of the insulating board 200. The first radiating arm 30 is shorter than the second radiating arm 50.

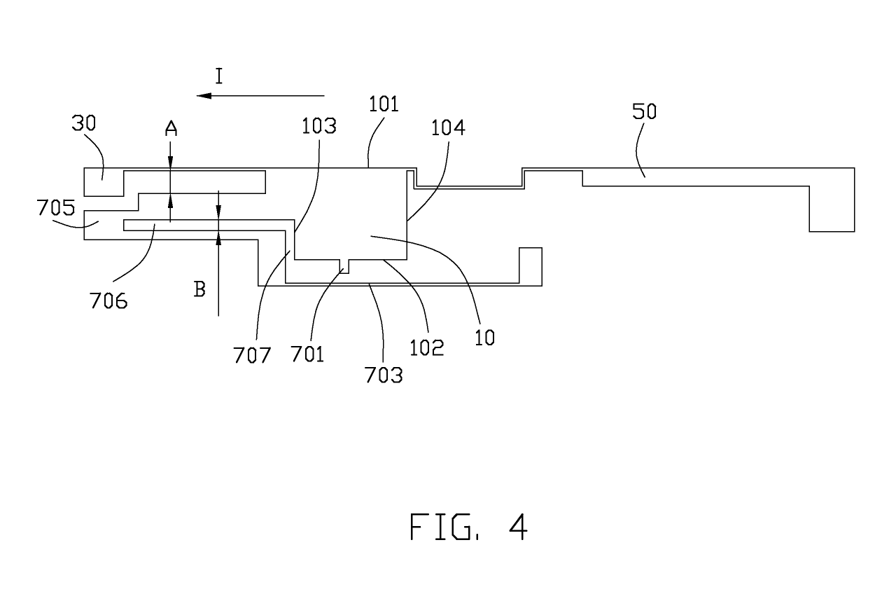

Referring to FIG. 4, the loop conductive portion 70 comprises a feed point portion 701 extending from the second end 102 of the base section 10, a grounding portion 703 parallel to the second end 102 and adjacent to the feed point portion 701, and a connecting portion 705 connecting the feed point portion 701 and the grounding portion 703. The connecting portion 705 firstly extends from the third end 103 of the base section 10 towards the first side 201 of the insulating board 200 and then extends backwardly towards the base section 10 in the longitudinal direction, and finally extends downwardly in the transverse direction connecting the grounding portion 703. The loop conductive portion 70 forms a main matching slot 706 and a secondary matching slot 707 beside the third end 103. The main matching slot 706 extends in the longitudinal direction while the secondary matching slot 707 extends in the transverse direction perpendicular to the longitudinal direction forming an L-shaped structure. The connecting portion 705 together with the first radiating arm 30 defines a gap, the width A of the gap is between one and four times the width B of the main matching slot 706.

Referring to FIG. 2, in order to strength the grounding effect, a metal foil 300 is pasted on the grounding portion 703. A coaxial cable 400 connects the antenna 100. The coaxial cable 400 comprises an inner conductor 401 connecting the feed point portion 701 and an outer conductor 403 connecting the metal foil 300.

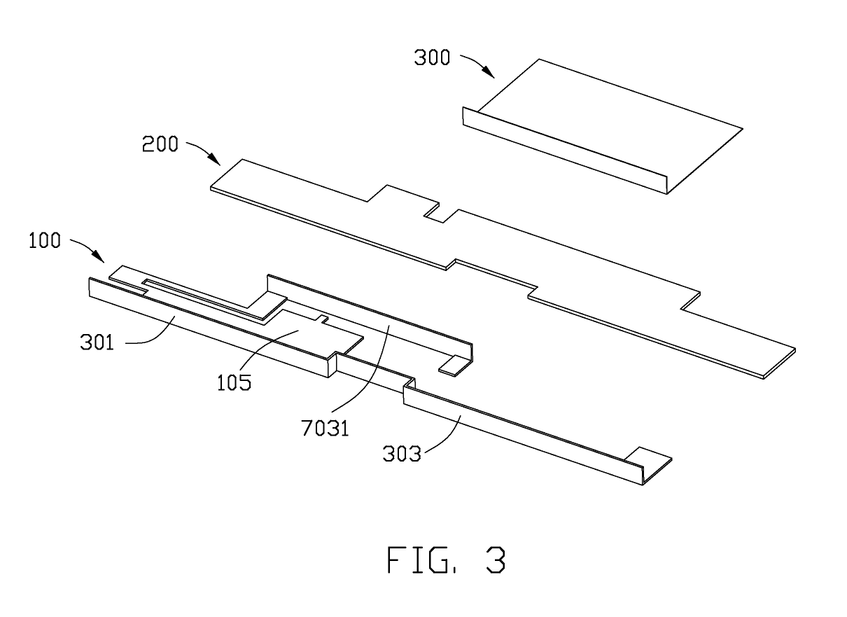

Referring to FIG. 3 and FIG. 4, in the preferred embodiment of the present disclosure, the antenna 100 is stamped and bent from a metal plate. The base section 10 locates on a first plane 105. The grounding portion 703 defines a second plane 7031 perpendicular to the first plane 105. The main matching slot 706 and the secondary matching slot 707 locate on the first plane 105. The first radiating arm 30 defines a third plane 301 while the second radiating arm 50 defines a fourth plane 303. The third plane 301 and the fourth plane 303 are perpendicular to the first plane 105 and parallel to the second plane 7031. The base section 10 locates between the third plane 303 and the second plane 7031. In the embodiment of the present disclosure, the third and fourth planes 301, 303 are coplanar. The first radiating arm 30 and/or the second radiating arm 50 define a portion located in the first plane 105 at the free end thereof. The first radiating arm 30 works on 1710˜2700 MHz while the second radiating arm 50 works on 704˜960 MHz. This structure of the antenna can meet the frequency bands requirements of both 3G and LTE.

While preferred embodiment in accordance with the present disclosure has been shown and described, equivalent modifications and changes known to persons skilled in the art according to the spirit of the present disclosure are considered within the scope of the present disclosure as defined in the appended claims.

What is claimed is:

1. A multi-band antenna comprising:
a base section comprising a first end and a second end opposite to each other;
a first radiating arm and a second radiating arm extending opposite to each other from the first end and locating on two opposite sides of the base section in a longitudinal direction; and
a loop conductive portion extending from the base section, the loop conductive portion comprising a grounding portion locating adjacent to the second end of the base section and a connecting portion extending in the longitudinal direction, the connecting portion locating on the same side of the base section with the first radiating arm and defining a main matching slot thereon.

2. The multi-band antenna as claimed in claim 1, wherein the connecting portion and the first radiating arm define a gap therebetween, the width of the gap is between one and four times the width of the main matching slot.

3. The multi-band antenna as claimed in claim 1, wherein the connecting portion defines a secondary matching slot communicating with the main matching slot forming an L-shaped structure.

4. The multi-band antenna as claimed in claim 1, wherein the base section locates in a first plane, the main matching slot locates in the first plane, the grounding portion locates in a second plane perpendicular to the first plane.

5. The multi-band antenna as claimed in claim 4, wherein the antenna comprises a feed point portion extending from the second end of the base portion towards the grounding portion.

6. The multi-band antenna as claimed in claim 5, wherein the feed point portion locates between the main matching slot and the second plane in a transverse direction perpendicular to the longitudinal direction.

7. The multi-band antenna as claimed in claim 4, wherein the first radiating arm defines a third plane parallel to the second plane, the base section locates between the third plane and the second plane.

8. The multi-band antenna as claimed in claim 1, wherein the antenna comprises a metal foil connecting with the grounding portion.

9. The multi-band antenna as claimed in claim 5, wherein the antenna is assembled on an insulating board, the insulating board comprises a recess corresponding to the feed point portion.

10. A multi-band antenna comprising:
a base section located in a first plane and defining a first end and a second end opposite to each other in a transverse direction;
a grounding portion located in a second plane, the grounding portion adjacent to the second end and spaced from the base section;
a connecting portion located in the first plane and connecting the base section and the grounding portion; and
a first and second radiating arms extending opposite to each other in a longitudinal direction and defining a third plane essentially parallel to the second plane, the first radiating arm and the connecting portion located in the same side of the base section in the longitudinal direction and defining a gap therebetween.

11. The multi-band antenna as claimed in claim 10, wherein the connecting portion defines a main matching slot extending in the longitudinal direction and a secondary matching slot extending in the transverse direction forming an L-shaped structure.

12. The multi-band antenna as claimed in claim 11, wherein the gap is parallel to the main matching slot and wherein the width of the gap is between one and four times the width of the main matching slot.

13. The multi-band antenna as claimed in claim 10, wherein at free end, the first and/or second radiating arm comprises a portion located in the first plane.

14. The multi-band antenna as claimed in claim 10, wherein the antenna comprises a feed point portion extending from the second end of the base portion towards the grounding portion for connecting a coaxial cable.

15. A multi-band antenna assembly comprising:
an antenna including:
a metallic base section located in a first plane;
at least a first radiating arm linked at an upper side of the base section;
a loop conductive portion defining unitarily a grounding portion and a connecting portion, said connecting portion linked to a first lateral side of the base section in said first plane;
a first upstanding Z-shaped slot formed between the base section and the loop conductive portion and lying in said first plane and laterally communicating with an exterior on a second lateral side of the base section opposite to said first lateral side; and
a coaxial cable including an inner conductor linked to a bottom side of the base section adjacent to the slot, and an outer conductor linked to a position adjacent to the grounding portion.

16. The multi-band antenna assembly as claimed in claim 15, wherein the connecting portion defines a lying Z-shaped configuration in said first plane beside said standing Z-shaped slot.

17. The multi-band antenna assembly as claimed in claim 15, wherein a second upstanding Z-shaped slot is formed beside the base section and located in said first plane above said first standing Z-shaped slot and laterally communicating with the exterior at the first lateral side of the base section.

18. The multi-band antenna assembly as claimed in claim 15, wherein said grounding portion lies in a second plane perpendicular to said first plane.

19. The multi-band antenna assembly as claimed in claim 18, further including a metallic foil linked to the grounding portion and extending primarily coplanar with the first plane, wherein the outer conductor of the coaxial cable is connected to said metallic foil.

20. The multi-band antenna assembly as claimed in claim 18, further including an insulative plate lying in a third plane intimately behind the first plane in a parallel relation to support the antenna, wherein the grounding portion abuts against a longitudinal edge of said insulative plate via assistance of said connecting portion at one end and an independent tab at the other end in a longitudinal direction.
